(19) United States
(12) Patent Application Publication
(10) Pub. No.: US 2022/0230067 A1
(43) Pub. Date: Jul. 21, 2022

(54) LEARNING DEVICE, LEARNING METHOD, AND LEARNING PROGRAM

(71) Applicant: NTT Communications Corporation, Tokyo (JP)

(72) Inventors: Yuki MIKI, Tokyo (JP); Ryosuke TANNO, Tokyo (JP); Keisuke KIRITOSHI, Kawasaki-shi (JP)

(73) Assignee: NTT Communications Corporation, Tokyo (JP)

(21) Appl. No.: 17/711,034

(22) Filed: Apr. 1, 2022

Related U.S. Application Data
(63) Continuation of application No. PCT/JP2020/037783, filed on Oct. 5, 2020.

(30) Foreign Application Priority Data
Oct. 4, 2019 (JP) 2019-184138

(51) Int. Cl. G06N 3/08; G06N 3/04

(52) U.S. Cl. CPC G06N 3/08; G06N 3/0454

(57) ABSTRACT

A learning device includes processing circuitry configured to acquire time series data related to a processing target, perform learning processing of updating parameters of a first model by using the time series data acquired as a data set for learning, and causing the first model to solve a first task, the first model including a neural network constituted of a plurality of layers, and perform learning processing of updating parameters of a second model by using the data set for learning, and causing the second model to solve a second task different from the first task, the second model including a neural network using, as initial values, the parameters of the first model subjected to the learning processing performed.

### CROSS-REFERENCE TO RELATED APPLICATIONS

This application is a continuation application of International Application No. PCT/JP2020/037783, filed on Oct. 5, 2020 which claims the benefit of priority of the prior Japanese Patent Application No. 2019-184138, filed on Oct. 4, 2019, the entire contents of which are incorporated herein by reference.

### FIELD

The present invention relates to a learning device, a learning method, and a learning program.

### BACKGROUND

To perform learning of a neural network, an initial value of weight needs to be set for each layer in advance, and an initial weight is often initialized as a random number. Dependence on the initial value is high such that learning results of the neural network may largely vary depending on the set initial value of weight, the weight needs to be appropriately initialized, and there are various methods of initializing weights. It is important to obtain a favorable initial value to improve accuracy, stabilize learning, accelerate convergence of loss of learning, suppress overlearning, and the like, which lead to a favorable learning result.

In particular, for a network configured by a convolutional neural network (hereinafter, abbreviated as CNN) that currently achieves the most remarkable success in the field of images, it is common to take an approach using a weight initial value called fine-tuning in which a target task is learned by using, as initial values of weight, learned parameters obtained by performing supervised learning using large-scale learning data in advance.

It is known that characteristics obtained from an intermediate layer of the CNN that has learned by using a high-quality large-scale data set such as ImageNet are very versatile, and the characteristics can also be used for various tasks such as object recognition, image conversion, and image retrieval.

As described above, in the field of images, fine-tuning is established as a basic technique, and various pre-learned models are shared as open source in a present situation. However, a transfer learning method such as the fine-tuning as described above is used in only the field of images and is not applicable to the other fields such as natural language processing and voice recognition.

In addition, research on application of neural networks to time series data is being developed, so that there are few research examples. In particular, a transfer learning method for time series data has not been established, and weight initialization of a network is typically performed by using random numbers.

The related technologies are described, for example, in: “Transfer learning for time series classification”, [online], [retrieved on 6th Sep. 2019], Internet <arxiv.org/pdf/1811.01533.pdf>.

However, there has been the problem in a related method that learning cannot be rapidly performed with high accuracy on a model related to time series data in some cases. For example, fine-tuning and transfer learning, which are typically performed in the field of images, are rarely used in the field of time series analysis. This is because time series data is difficult to be simply fine-tuned because domains (a target, a data collection process, average/variance/characteristic of data, a generation process) differ from data to data. Another factor is that a general-purpose and large-scale data set such as ImageNet in the field of images is not present.

Thus, in learning of a model using time series data as an input, it is common to use a random value as a weight initial value of the model without using fine-tuning or transfer learning, but there has been the problem that accuracy is low and a learning speed is slow, accordingly.

### SUMMARY

It is an object of the present invention to at least partially solve the problems in the related technology.

According to an aspect of the embodiments, a learning device includes: processing circuitry configured to: acquire time series data related to a processing target; perform learning processing of updating parameters of a first model by using the time series data acquired as a data set for learning, and causing the first model to solve a first task, the first model including a neural network constituted of a plurality of layers; and perform learning processing of updating parameters of a second model by using the data set for learning, and causing the second model to solve a second task different from the first task, the second model including a neural network using, as initial values, the parameters of the first model subjected to the learning processing performed.

The above and other objects, features, advantages and technical and industrial significance of this invention will be better understood by reading the following detailed description of presently preferred embodiments of the invention, when considered in connection with the accompanying drawings.

### BRIEF DESCRIPTION OF DRAWINGS

FIG. 1 is a block diagram illustrating a configuration example of a learning device according to a first embodiment;

FIG. 2 is a diagram for explaining processing of updating parameters of an entire model;

FIG. 3 is a diagram for explaining processing of updating part of the parameters of the model;

FIG. 4 is a diagram for explaining an outline of learning processing performed by the learning device;

FIG. 5 is a flowchart illustrating an example of a procedure of learning processing performed by the learning device according to the first embodiment; and

FIG. 6 is a diagram illustrating a computer that executes a learning program.

### DESCRIPTION OF EMBODIMENTS

The following describes embodiments of a learning device, a learning method, and a learning program according to the present application in detail based on the drawings. The learning device, the learning method, and the learning program according to the present application are not limited to the embodiments.

### First embodiment

The following embodiment describes a configuration of a learning device 10 according to a first embodiment and a procedure of processing performed by the learning device 10 in order, and lastly describes an effect of the first embodiment.

Configuration of Learning Device

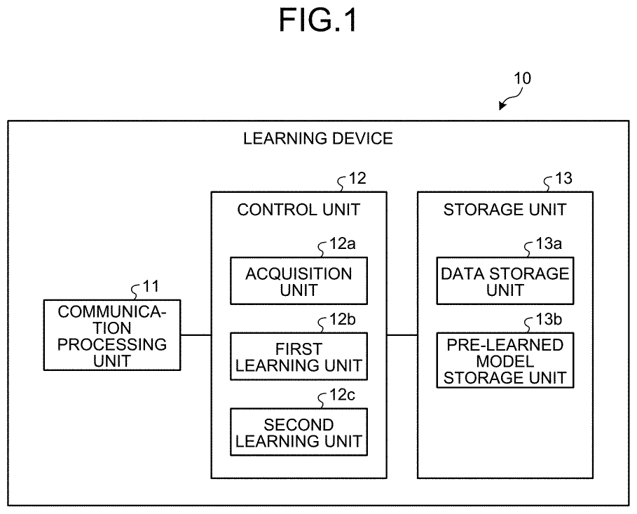

First, the following describes the configuration of the learning device 10 with reference to FIG. 1. FIG. 1 is a block diagram illustrating a configuration example of the learning device according to the first embodiment. The learning device 10 is a device that learns a model using time series data as an input. The model learned by the learning device 10 may be any model. For example, the learning device 10 collects a plurality of pieces of data acquired by a sensor installed in a facility to be monitored such as a factory or a plant and uses the collected pieces of data as inputs to learn a model for estimating an anomaly in the facility to be monitored.

As illustrated in FIG. 1, the learning device 10 includes a communication processing unit 11, a control unit 12, and a storage unit 13. The following describes processing performed by each unit included in the learning device 10.

The communication processing unit 11 controls communication related to various kinds of information exchanged with a connected device. The storage unit 13 stores data and computer programs requested for various kinds of processing performed by the control unit 12 and includes a data storage unit 13a and a pre-learned model storage unit 13b. For example, the storage unit 13 is a storage device such as a semiconductor memory element including a random access memory (RAM), a flash memory, and the like.

The data storage unit 13a stores time series data acquired by an acquisition unit 12a described later. For example, the data storage unit 13a stores data from sensors disposed in target appliances in a factory, a plant, a building, a data center, and the like (for example, data such as a temperature, a pressure, sound, and vibration), and data from sensors attached to a human body (for example, acceleration data of an acceleration sensor).

The pre-learned model storage unit 13b stores a pre-learned model learned by a second learning unit 12c described later. For example, the pre-learned model storage unit 13b stores, as the pre-learned model, an estimation model of a neural network for estimating an anomaly in the facility to be monitored.

The control unit 12 includes an internal memory for storing requested data and computer programs specifying various processing procedures and executes various kinds of processing therewith. For example, the control unit 12 includes the acquisition unit 12a, a first learning unit 12b, and the second learning unit 12c. Herein, the control unit 12 is, for example, an electronic circuit such as a central processing unit (CPU), a micro processing unit (MPU), and a graphical processing unit (GPU), or an integrated circuit such as an application specific integrated circuit (ASIC) and a field programmable gate array (FPGA).

The acquisition unit 12a acquires time series data related to a processing target. For example, the acquisition unit 12a acquires sensor data. As a concrete example, the acquisition unit 12a periodically (for example, every minute) receives, for example, multivariate time-series numerical data from a sensor installed in the facility to be monitored such as a factory or a plant, and stores the data in the data storage unit 13a.

Herein, the data acquired by the sensor is, for example, various kinds of data such as a temperature, a pressure, sound, and vibration related to a device or a reactor in the factory or a plant as the facility to be monitored. The sensor data is not limited to the data described above. The acquisition unit 12a may acquire, for example, the sensor data from an acceleration sensor attached to a human body as the sensor data. The data acquired by the acquisition unit 12a is not limited to the data acquired by the sensor but may be numerical data input by a person, for example.

The first learning unit 12b performs learning processing of updating parameters of a first model by causing the first model, which includes a neural network constituted of a plurality of layers, to solve a first task by using the time series data acquired by the acquisition unit 12a as a data set for learning.

For example, the first learning unit 12b reads out the time series data stored in the data storage unit 13a as the data set for learning. The first learning unit 12b then performs, for example, learning processing of updating the parameters of the first model by inputting the data set for learning to the neural network constituted of an input layer, a convolutional layer, a fully connected layer, and an output layer, and causing the first model to solve a pseudo task different from a task originally desired to be solved (target task).

The second learning unit 12c performs learning processing of updating parameters of a second model by causing the second model, which includes a neural network using the parameters of the first model subjected to the learning processing performed by the first learning unit 12b as initial values, to solve a second task different from the first task by using the data set for learning.

For example, the second learning unit 12c reads out the same time series data as the time series data used by the first learning unit 12b from the data storage unit 13a as the data set for learning. The second learning unit 12c then performs learning processing of updating the parameters of the second model by inputting the data set for learning using the model learned by the first learning unit 12b as initial values, and causing the second model to solve the task originally desired to be solved.

Herein, the second learning unit 12c may perform learning processing of updating the parameters of the entire second model by causing the second model to solve the second task, or may perform learning processing of updating part of the parameters of the second model by causing the second model to solve the second task.

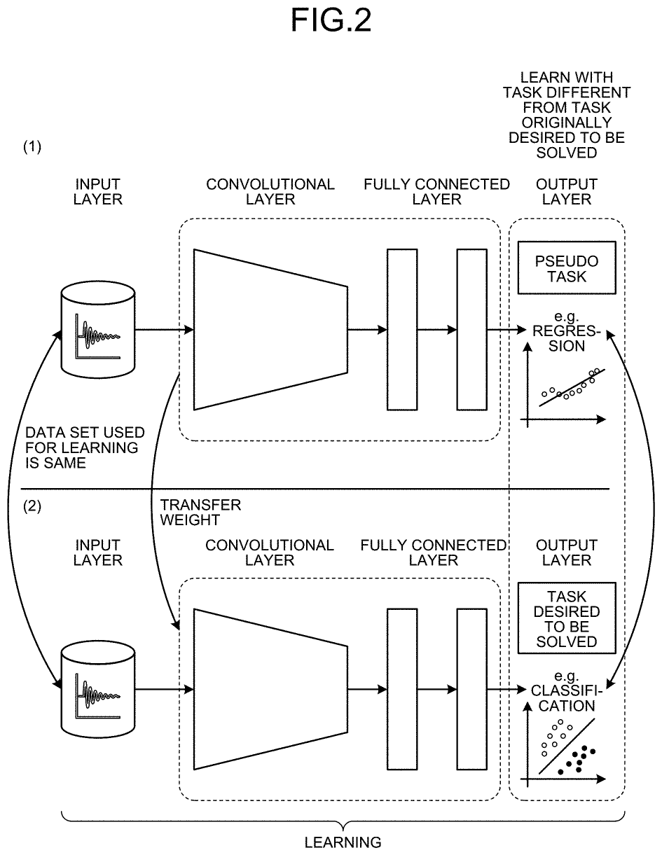

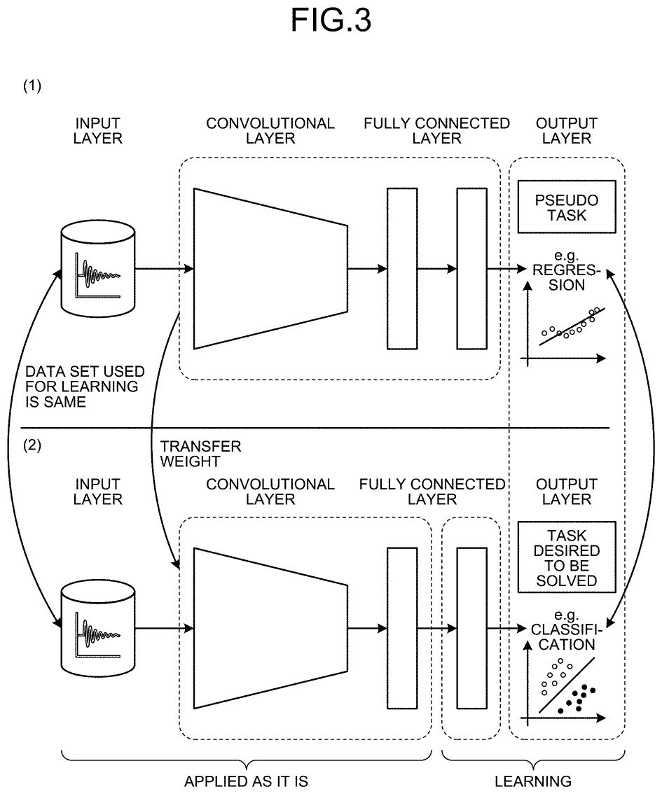

The following describes the learning processing performed by the learning device 10 with reference to FIG. 2 and FIG. 3. FIG. 2 is a diagram for explaining the processing of updating the parameters of the entire model. FIG. 3 is a diagram for explaining the processing of updating part of the parameters of the model. In the examples of FIG. 2 and FIG. 3, (1) represents learning processing performed by the first learning unit 12b and (2) represents learning processing performed by the second learning unit 12c.

As illustrated in FIG. 2 (1) and FIG. 3 (1), first, the first learning unit 12b of the learning device 10 performs self-supervised learning with a pseudo task (for example, regression), which is different from the task originally desired to be solved, to obtain a weight initial value of the first model.

Then, in the example of FIG. 2 (2), the second learning unit 12c of the learning device 10 inputs the same data set for learning as that in FIG. 2 (1) using the first model learned by the first learning unit 12b as the initial values, and causes the second model to solve the task originally desired to be solved to perform fine-tuning of the entire second model (the input layer, the convolutional layer, the fully connected layer, and the output layer).

In the example of FIG. 3 (2), the second learning unit 12c of the learning device 10 inputs the same data set for learning as that in FIG. 3 (1) using the first model learned by the first learning unit 12b as the initial values, and causes the second model to solve the task originally desired to be solved to perform fine-tuning of part of the second model.

For example, as exemplified in FIG. 3 (2), the second learning unit 12c applies the parameters as they are to the input layer, the convolutional layer, and part of the fully connected layer, and performs fine-tuning only on the other part of the fully connected layer and the output layer. That is, the second learning unit 12b applies the parameters learned by the first learning unit 12b as they are to some layers closer to the input layer, and performs the learning processing with a task desired to be solved only for some layers closer to the output layer.

In this way, the second learning unit 12c of the learning device 10 inputs the data set for learning using the first model learned by the first learning unit 12b as the initial values, and causes the second model to solve the task originally desired to be solved to perform fine-tuning of the second model. That is, the learning device 10 performs fine-tuning and transfer learning on the time series data, which has been difficult in the related art, by performing self-supervised learning on the time series data.

The pseudo task described above may be any task that is different from the target task originally desired to be solved, and any task may be set in a pseudo manner. For example, in a case in which the target task originally desired to be solved is a task for classifying the sensor data (for example, a task for classifying a behavior from an acceleration sensor attached to a body), a task for estimating a value of the sensor data after a predetermined time elapses may be set as the pseudo task.

In this case, for example, the first learning unit 12b performs learning processing of updating the parameters of the first model by using the sensor data acquired by the acquisition unit 12a as the data set for learning, and causing the first model to solve the task for estimating the value of the sensor data after the predetermined time elapses. That is, the first learning unit 12b performs learning of the first model with the task for estimating a future value of a certain sensor among a plurality of sensors several steps later, the task acquired as the pseudo task, for example.

The second learning unit 12c then performs learning processing of updating the parameters of the model by causing the model to solve a task for classifying the sensor data using, as the initial values, the parameters of the model subjected to the learning processing performed by the first learning unit 12b, using the data set for learning. That is, the second learning unit 12c performs fine-tuning of the second model with the task for classifying the sensor data using, as the initial values, the first model learned by the first learning unit 12b.

For example, in a case in which the target task originally desired to be solved is a task for detecting an abnormal value of the sensor data (for example, a task for detecting an abnormal behavior from an acceleration sensor attached to a body), a task for estimating a value of the sensor data after a predetermined time elapses may be set as the pseudo task.

In this case, for example, the first learning unit 12b performs learning processing of updating the parameters of the first model by using the sensor data acquired by the acquisition unit 12a as the data set for learning, and causing the first model to solve the task for estimating the value of the sensor data after the predetermined time elapses. That is, the first learning unit 12b performs learning of the first model with the task for estimating a future value of a certain sensor among a plurality of sensors several steps later, the task acquired as the pseudo task.

The second learning unit 12c then performs learning processing of updating the parameters of the model by causing the model to solve the task for detecting the abnormal value of the sensor data using, as the initial values, the parameters of the first model subjected to the learning processing performed by the first learning unit 12b. That is, the second learning unit 12c performs fine-tuning of the second model with the task for detecting an anomaly in the sensor data using the model learned by the first learning unit 12b as the initial values.

For example, in a case in which the target task originally desired to be solved is a task for estimating the value of the sensor data after a predetermined time elapses (for example, a task for estimating acceleration several seconds later from an acceleration sensor attached to a body), a task for rearranging pieces of the sensor data, which are partitioned at certain intervals and randomly rearranged, in correct order may be set as the pseudo task.

In this case, for example, the first learning unit 12b uses the sensor data acquired by the acquisition unit 12a as the data set for learning and updates the parameters of the first model by causing the first model to solve the task for rearranging pieces of the sensor data, which are partitioned at certain intervals and randomly rearranged, in correct order. That is, the first learning unit 12b performs, for example, learning for rearranging a plurality of pieces of the sensor data, which are partitioned at certain intervals and randomly rearranged, in correct order, which is acquired as the pseudo task.

The second learning unit 12c then updates the parameters of the second model by causing the second model to solve the task for estimating the value of the sensor data after the predetermined time elapses using, as the initial values, the parameters of the first model subjected to the learning processing performed by the first learning unit 12b, using the data set for learning. That is, the second learning unit 12c performs fine-tuning of the model with a task for regressing the sensor data using the learned model as the initial values.

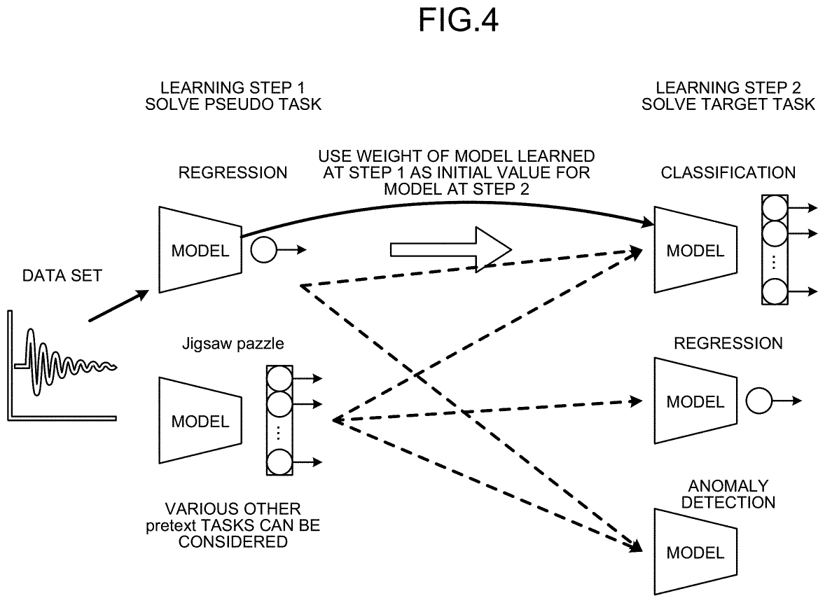

Herein, the following describes an outline of learning processing performed by the learning device 10 with reference to the example in FIG. 4. FIG. 4 is a diagram for explaining the outline of the learning processing performed by the learning device. As exemplified in FIG. 4, the learning device 10 performs two learning steps including a learning step of solving the pseudo task (learning STEP 1) and a learning step of solving the target task originally desired to be solved (learning STEP 2). The learning device 10 uses the weight of the model learned at the learning STEP 1 as an initial value for the model at the learning STEP 2.

That is, the first learning unit 12b of the learning device 10 performs self-supervised learning with a pseudo task (for example, regression) different from the task originally desired to be solved to obtain a weight initial value of the first model.

The second learning unit 12c of the learning device 10 then performs fine-tuning of the second model by inputting the data set for learning using the first model learned by the first learning unit 12b as the initial values, and causes the second model to solve the task originally desired to be solved (for example, classification). That is, the learning device 10 performs fine-tuning on the time series data, which has been difficult in the related art, by performing self-supervised learning on the time series data. In the example of FIG. 4, the pseudo task (pretext task) exemplifies a task for regressing the sensor data or a task for rearranging randomly rearranged pieces of the sensor data in correct order (Jigsaw puzzle), but any other task may be employed.

In this way, the first learning unit 12c of the learning device 10 performs self-supervised learning with a pseudo task (for example, regression) that is different from the task originally desired to be solved to obtain the weight initial value of the first model. The second learning unit 12c of the learning device 10 then performs fine-tuning of the second model by inputting the data set for learning using the first model learned by the first learning unit 12b as the initial values, and causing the second model to solve the task originally desired to be solved. That is, the learning device 10 can perform fine-tuning on the time series data, which has been difficult in the related art, by performing self-supervised learning on the time series data and can rapidly perform learning on the model related to the time series data with high accuracy.

Processing Procedure of Learning Device

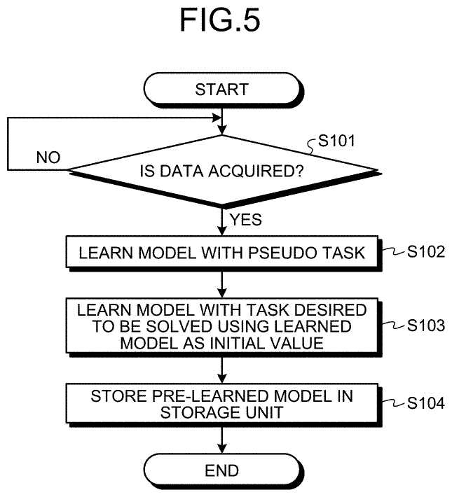

Next, the following describes an example of a processing procedure performed by the learning device 10 according to the first embodiment with reference to FIG. 5. FIG. 5 is a flowchart illustrating an example of a procedure of learning processing performed by the learning device according to the first embodiment.

As exemplified in FIG. 5, if the acquisition unit 12a of the learning device 10 acquires data (Yes at Step S101), the first learning unit 12b learns the model with a pseudo task (Step S102). For example, the first learning unit 12b performs learning processing of updating the parameters of the first model by inputting the data set for learning to the neural network and causing the first model to solve the pseudo task that is different from the task originally desired to be solved.

Subsequently, the second learning unit 12c learns the model with the task desired to be solved using the learned model as the initial values (Step S103). For example, the second learning unit 12c performs learning processing of updating the parameters of the second model by inputting the data set for learning using the model learned by the first learning unit 12b as the initial values, and causing the second model to solve the task originally desired to be solved.

When the second learning unit 12c ends the learning processing while satisfying a predetermined end condition, the pre-learned model is stored in the pre-learned model storage unit 13c of the storage unit 13 (Step S104).

Effect of First Embodiment

The learning device 10 according to the first embodiment acquires the time series data related to the processing target. The learning device 10 then performs learning processing of updating the parameters of the first model by using the acquired time series data as a data set for learning, and causing the first model, which includes the neural network constituted of a plurality of layers, to solve the first task. Subsequently, the learning device 10 performs learning processing of updating the parameters of the second model by using the data set for learning, and causing the second model to solve a second task different from the first task, the second model including a neural network using, as initial values, the parameters of the first model subjected to the learning processing. Accordingly, the learning device 10 according to the first embodiment can rapidly perform learning of the model related to the time series data with high accuracy.

That is, the learning device 10 according to the first embodiment enables fine-tuning of the time series data, which has been difficult in the related art, and accuracy, a learning speed, and versatility are improved as compared with learning using random initial values for the model.

In self-supervised learning in a related field of images, an appropriate pretext task (pseudo task) needs to be set in accordance with a domain of an image. However, with the learning device 10 according to the first embodiment, for example, regression for estimating data after several steps can be easily set for the time series data because of a property thereof, so that a load of considering the pseudo task is small. Due to characteristics of the time series data, it is easy to solve a regression task as the pseudo task, which has a high affinity with self-supervised learning.

For example, the learning device 10 acquires characteristic expression of data that is effective for the target task desired to be solved with respect to the time series data by solving the pseudo task in advance. The other advantages of self-supervised learning are that a new data set with a label is not required to be created and that a large majority of unlabeled data can be utilized. Using self-supervised learning for the time series data enables fine-tuning that has been difficult because a general-purpose and large-scale data set is not present, and accuracy and generalizing performance for various tasks for the time series data can be expected to be improved.

System Configuration and Like

The components of the devices illustrated in the drawings are merely conceptual, and it is not required that they are physically configured as illustrated necessarily. That is, specific forms of distribution and integration of the devices are not limited to those illustrated in the drawings. All or part thereof may be functionally or physically distributed/integrated in arbitrary units depending on various loads or usage states. All or optional part of the processing functions performed by the respective devices may be implemented by a CPU or a GPU and computer programs analyzed and executed by the CPU or the GPU, or may be implemented as hardware using wired logic.

Among pieces of the processing described in the present embodiment, all or part of the pieces of processing described to be automatically performed can be manually performed, or all or part of the pieces of processing described to be manually performed can be automatically performed by using a related method. Additionally, the processing procedures, control procedures, specific names, and information including various kinds of data and parameters described herein or illustrated in the drawings can be optionally changed unless otherwise specifically noted.

Computer Program

It is also possible to create a computer program describing the processing performed by the learning device described in the above embodiment in a computer-executable language. For example, it is possible to create a computing program describing the processing performed by the learning device 10 according to the embodiment in a computer-executable language. In this case, the same effect as that of the embodiment described above can be obtained when the computer executes the computing program. Furthermore, such a computing program may be recorded in a computer-readable recording medium, and the computing program recorded in the recording medium may be read and executed by the computer to implement the same processing as that in the embodiment described above.

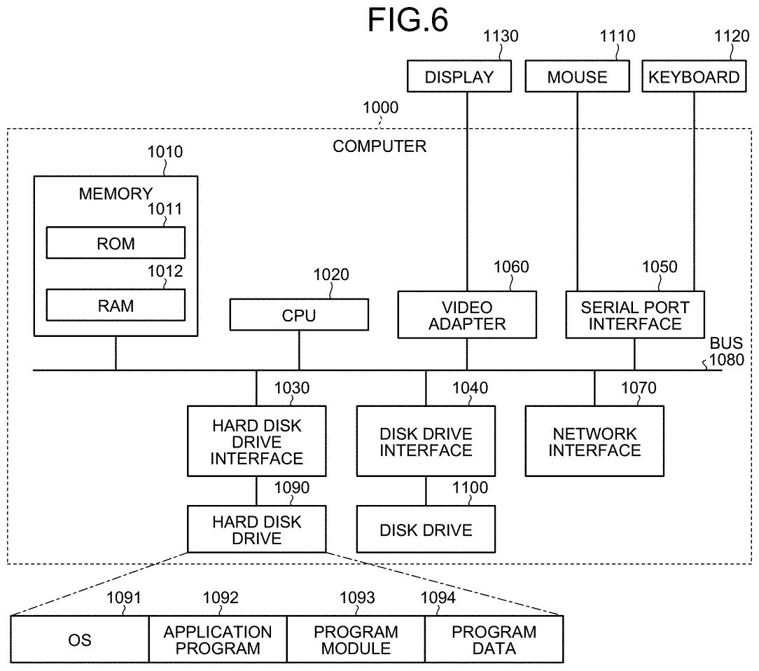

FIG. 6 is a diagram illustrating the computer that executes the computing program. As exemplified in FIG. 6, a computer 1000 includes, for example, a memory 1010, a CPU 1020, a hard disk drive interface 1030, a disk drive interface 1040, a serial port interface 1050, a video adapter 1060, and a network interface 1070, which are connected to each other via a bus 1080.

As exemplified in FIG. 6, the memory 1010 includes a read only memory (ROM) 1011 and a RAM 1012. The ROM 1011 stores, for example, a boot program such as a Basic Input Output System (BIOS). As exemplified in FIG. 6, the hard disk drive interface 1030 is connected to a hard disk drive 1090. As exemplified in FIG. 6, the disk drive interface 1040 is connected to a disk drive 1100. For example, a detachable storage medium such as a magnetic disc or an optical disc is inserted into the disk drive 1100. As exemplified in FIG. 6, the serial port interface 1050 is connected to a mouse 1110 and a keyboard 1120, for example. As exemplified in FIG. 6, the video adapter 1060 is connected to a display 1130, for example.

Herein, as exemplified in FIG. 6, the hard disk drive 1090 stores, for example, an OS 1091, an application program 1092, a program module 1093, and program data 1094. That is, the computing program described above is stored in the hard disk drive 1090, for example, as a program module describing a command executed by the computer 1000.

The various kinds of data described in the above embodiment are stored in the memory 1010 or the hard disk drive 1090, for example, as program data. The CPU 1020 then reads out the program module 1093 or the program data 1094 stored in the memory 1010 or the hard disk drive 1090 into the RAM 1012 as needed, and performs various processing procedures.

The program module 1093 and the program data 1094 related to the computing program are not necessarily stored in the hard disk drive 1090, but may be stored in a detachable storage medium, for example, and may be read out by the CPU 1020 via a disk drive and the like. Alternatively, the program module 1093 and the program data 1094 related to the computing program may be stored in another computer connected via a network (a local area network (LAN), a wide area network (WAN), and the like), and may be read out by the CPU 1020 via the network interface 1070.

According to the present invention, learning can be rapidly performed with high accuracy on a model related to time series data.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A learning device comprising:
processing circuitry configured to:
acquire time series data related to a processing target;
perform learning processing of updating parameters of a first model by using the time series data acquired as a data set for learning, and causing the first model to solve a first task, the first model including a neural network constituted of a plurality of layers; and
perform learning processing of updating parameters of a second model by using the data set for learning, and causing the second model to solve a second task different from the first task, the second model including a neural network using, as initial values, the parameters of the first model subjected to the learning processing performed.

2. The learning device according to claim 1, wherein the processing circuitry is further configured to perform learning processing of updating parameters of the entire second model by causing the second model to solve the second task.

3. The learning device according to claim 1, wherein the processing circuitry is further configured to perform learning processing of updating part of the parameters of the second model by causing the second model to solve the second task.

4. The learning device according to claim 1, wherein the processing circuitry is further configured to:
acquire sensor data as the time series data,
perform learning processing of updating the parameters of the first model by using the sensor data acquired as a data set for learning, and causing the first model to solve a task for estimating a value of the sensor data after a predetermined time elapses, and
perform learning processing of updating the parameters of the second model by using the data set for learning, and causing the second model to solve a task for classifying the sensor data by using, as initial values, the parameters of the first model subjected to the learning processing performed.

5. The learning device according to claim 1, wherein the processing circuitry is further configured to:
acquire sensor data as the time series data,
perform learning processing of updating the parameters of the first model by using the sensor data acquired as a data set for learning, and causing the first model to solve a task for estimating a value of the sensor data after a predetermined time elapses, and
perform learning processing of updating the parameters of the second model by using the data set for learning, and causing the second model to solve a task for detecting an abnormal value of the sensor data by using, as initial values, the parameters of the first model subjected to the learning processing performed.

6. The learning device according to claim 1, wherein the processing circuitry is further configured to:
acquire sensor data as the time series data,
perform learning processing of updating the parameters of the first model by using the sensor data acquired as a data set for learning, and causing the first model to solve a task for rearranging pieces of the sensor data, which are partitioned at certain intervals and randomly rearranged, in correct order, and
perform learning processing of updating the parameters of the second model by using the data set for learning, and causing the second model to solve a task for estimating a value of the sensor data after a predetermined time elapses by using, as initial values, the parameters of the first model subjected to the learning processing performed.

7. A learning method comprising:
acquiring time series data related to a processing target;
performing first learning processing of updating parameters of a first model by using the time series data acquired at the acquiring as a data set for learning, and causing the first model to solve a first task, the first model including a neural network constituted of a plurality of layers, by processing circuitry; and
performing second learning processing of updating parameters of a second model by using the data set for learning, and causing the second model to solve a second task different from the first task, the second model including a neural network using, as initial values, the parameters of the first model subjected to the learning processing performed at the first learning processing.

8. A non-transitory computer-readable recording medium storing therein a learning program that causes a computer to execute a process comprising:
acquiring time series data related to a processing target;
performing first learning processing of updating parameters of a first model by using the time series data acquired at the acquiring as a data set for learning, and causing the first model to solve a first task, the first model including a neural network constituted of a plurality of layers; and
performing second learning processing of updating parameters of a second model by using the data set for learning, and causing the second model to solve a second task different from the first task, the second model including a neural network using, as initial values, the parameters of the first model subjected to the learning processing performed at the first learning processing.
